(19) United States
(12) Patent Application Publication
(10) Pub. No.: US 2017/0153001 A1
(43) Pub. Date: Jun. 1, 2017

(54) LIGHTING AND/OR SIGNALING DEVICE FOR A MOTOR VEHICLE

(71) Applicant: Valeo Vision Belgique, Meslin l'Eveque (BE)

(72) Inventor: Cyril Herbin, Potelle (FR)

(21) Appl. No.: 15/358,358

(22) Filed: Nov. 22, 2016

(30) Foreign Application Priority Data
Nov. 26, 2015 (FR) 1561410

(51) Int. Cl. F21S 8/10

(52) U.S. Cl. CPC F21S 48/2206; F21S 48/2225

(57) ABSTRACT

A lighting and/or signaling device for a motor vehicle comprising a housing, a light guide, a light guide support and a mask, in which the light guide support and the mask each comprise a tab for snap-fitting in the housing, and the housing comprises a snap-fitting cladding for the light guide support and for the mask.

### CROSS-REFERENCE TO RELATED APPLICATIONS

This application claims priority to the French application 1561410, filed November 26, 2015, which application is incorporated herein by reference and made a part hereof.

BACKGROUND OF THE INVENTION

1. Field of the Invention

The invention relates to a lighting and/or signaling device for a motor vehicle, and more particularly such a device comprising a housing, a light guide, a light guide support and a mask for a light guide.

2. Description of the Related Art

In the known lighting devices, the different segments are fixed to the housing by individual means. That makes the structure of the housing and the operations of mold stripping thereof complex. The operations involved in mounting the different elements in the housing are also complex because of the number of movements to be performed in the limited space of the interior of the housing.

### SUMMARY OF THE INVENTION

One aim of the invention is to propose a lighting and/or signaling device for a motor vehicle which does not present these drawbacks, that makes it possible to minimize the movements inside the housing, and simplifies the assembly process.

The subject of the present invention is a lighting and/or signaling device for a motor vehicle, comprising a housing, a light guide, a light guide support and a mask, in which the light guide support and the mask each comprise a tab for snap-fitting in the housing, and the housing comprises a snap-fitting cladding for the light guide support and the mask.

Advantageously, the snap-fitting cladding for the light guide support and for the mask comprises a lateral wall and two crosspieces protruding from the lateral wall for snap-fitting the snap-fitting tabs behind the crosspieces, respectively the one of the light guide support and the other of the mask.

Advantageously, the crosspieces are arranged at right angles to the lateral wall.

Advantageously, each crosspiece bears, on its face accessible from the opening of the housing, at least one inclined guiding ramp for a snap-fitting tab.

Advantageously, the snap-fitting cladding of the light guide support and of the mask comprises a flared input opening to ensure the lateral guiding of the snap-fitting tabs of the light guide support and of the mask.

Advantageously, the light guide support and the mask are elastically deformable for the snap-fitting of the snap-fitting tabs.

Advantageously, the light guide support and/or the mask comprise at least two segments each having a snap-fitting tab, the snap-fitting tabs of the different segments being displaced in different directions in the snap-fitting.

Advantageously, the light guide support and the mask comprise two tabs that are displaced in substantially opposite directions.

Advantageously, the snap-fitting tabs are displaced toward one another.

These and other objects and advantages of the invention will be apparent from the following description, the accompanying drawings and the appended claims.

### BRIEF DESCRIPTION OF THE ACCOMPANYING DRAWINGS

Other features and advantages of the invention will emerge from the following description given with reference to the attached drawings in which:

FIG. 1 is a perspective view of the interior of a motor vehicle lighting and/or signaling device housing according to an exemplary embodiment of the invention;

FIG. 2 is a partial exploded perspective view of a mask for a light guide for a lighting and/or signaling device for a motor vehicle according to an exemplary embodiment of the invention;

FIG. 3 is a partial perspective view of a light guide support for a lighting and/or signaling device for a motor vehicle according to an exemplary embodiment of the invention; and

FIG. 4 is a partial cross-sectional view of the assembly of the housing of FIG. 1, of the mask of FIG. 2 and of the light guide support of FIG. 3 in operating configuration.

### DETAILED DESCRIPTION OF THE PREFERRED EMBODIMENTS

The motor vehicle lighting and/or signaling device housing 1 is of complex and non-symmetrical form.

According to the invention, the housing 1 comprises a substantially planar lateral wall 2 substantially at right angles to the bottom 3 of the housing 1.

In configuration of use, the bottom 3 of the housing 1 is substantially vertical and the opening of the housing 1 is oriented toward the front of the vehicle. The opening of the housing 1 is of complex form and it is symbolized by the free edge 4 of the lateral wall 2.

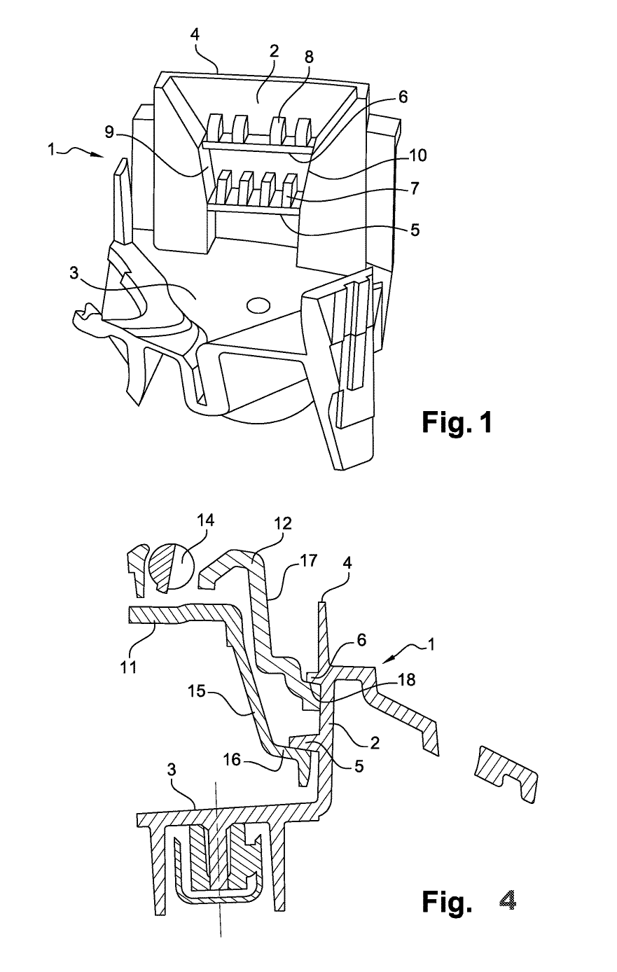

Starting from the bottom 3 of the housing 1, the lateral wall 2 bears a first crosspiece 5 and a second crosspiece 6, protruding from the lateral wall 2, toward the interior of the housing 1 as shown in FIG. 1. The first and second crosspieces 5 and 6 are parallel to one another and substantially parallel to the bottom 3 of the housing 1 in the exemplary embodiment represented. The first and second crosspieces 5 and 6 are arranged at right angles to the lateral wall 2.

On their face accessible from the opening of the housing 1, the crosspieces 5, 6 each bear at least one inclined ramp 7, 8.

The first and second crosspieces 5, 6 are housed between two partitions 9, 10, substantially at right angles to the lateral wall 2. The lateral wall 2, the two partitions 9, 10 and the first and second crosspieces 5, 6 together constitute a snap-fitting cladding for a light guide support 11 and a mask 12 for a light guide as show in FIGS. 1 and 4. Between the bottom 3 of the housing 1 and the free edge 4 of the lateral wall 2, the two partitions 9, 10 are inclined at each point where they pass the first and second crosspieces 5, 6 so as to constitute, for the snap-fitting cladding, a flared input opening.

The light guide support 11 comprises a plate 13 bearing the light guide 14, and tabs for attachment to the housing 1. In particular, the light guide support 11 comprises a snap-fitting tab 15 having, in the vicinity of the free end thereof, a tread 16 capable of cooperating with the first crosspiece 5 to ensure that the light guide support 11 is in the housing 1.

The mask 12 for the light guide 14 ensures the lateral protection of the light guide 14 and the limiting of the radiant field thereof. The mask 12 comprises tabs for attachment to the housing 1.

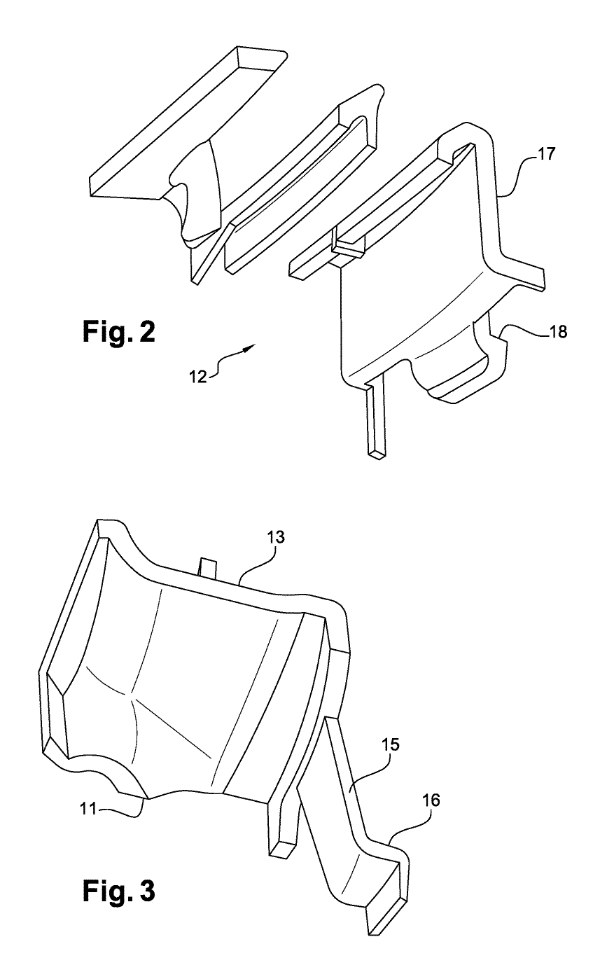

In particular, the mask 12 comprises a snap-fitting tab 17 having, in the vicinity of the free end thereof, a tread 18 (as shown in FIG. 2) capable of cooperating with the second crosspiece 6 to ensure that the mask 12 for the light guide 14 is held in the housing 1.

With the housing 1 in stable position, on the motor vehicle for example, the light guide support 11 is present for the fitting thereof. The light guide support 11 is elastically deformable.

Advantageously, the light guide support 11 comprises at least two segments each having a tab for attachment to the housing 1. These attachment tabs are displaced in different directions upon their attachment to the housing 1. Advantageously, these directions are substantially opposite, and preferably the attachment tabs are displaced toward one another for the snap-fitting.

For its fitting in the housing 1, the light guide support 11 is offered up to the housing 1. The snap-fitting tab 15 is inserted into the snap-fitting cladding, the flared input opening of which ensures the lateral guiding of the snap-fitting tab 15. The inclined ramps 8 and 7 ensure, at the end of the snap-fitting tab 15, that the first and second crosspieces 5 and 6 are passed respectively. The tread 16 is then pushed back, by the elasticity of the light guide support 11, behind the first crosspiece 5 and it ensures that the light guide support 11 is held in position.

For the mask 12 for the light guide 14, the fitting proceeds in the same way with only the second crosspiece 6 passed, behind which the tread 18 bears. The relative positions of the housing 1, of the light guide support 11 and of the mask 12 for light guide 14 are then those represented in FIG. 4.

The lighting and/or signaling device for a motor vehicle according to the invention presents a number of advantages. The housing 1 comprises a snap-fitting cladding for two different components, the light guide support 11 and the mask 12. The snap-fitting cladding has a flared input opening which ensures the easy fitting and lateral guiding of the light guide support 11 and of the mask 12.

The snap-fitting cross-pieces for the tabs of the light guide support 11 and of the mask 12 are arranged on the same lateral wall 2, and parallel to one another, which on the one hand simplifies the structure of the housing 1, and on the other hand ensures, for the housing 1, easy mold-stripping in a single movement.

The fixing of the light guide support 11 and of the mask 12 by snap-fitting ensures that movements of parts in the housing 1 are reduced to a minimum, that the tools needed for fitting the parts are substantially reduced and that the corresponding costs are reduced.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting and/or signaling device for a motor vehicle comprising a housing, a light guide, a light guide support and a mask, in which said light guide support and said mask each comprise a tab for snap-fitting in said housing, and said housing comprises a snap-fitting cladding for said light guide support and said mask.

2. The lighting and/or signaling device according to claim 1, in which said snap-fitting cladding for said light guide support and said mask comprises a lateral wall and two crosspieces protruding from said lateral wall for snap-fitting said tabs behind said two crosspieces, respectively said tab of said light guide support and said tab of said mask.

3. The lighting and/or signaling device according to claim 2, in which said two crosspieces are arranged at right angles to said lateral wall.

4. The lighting and/or signaling device according to claim 3, in which each of said two crosspieces bears, on its face accessible from the opening of said housing, at least one inclined guiding ramp for snap-fitting said tab.

5. The lighting and/or signallng device according to claim 1, in which said snap-fitting cladding of said light guide support and of said mask comprises a flared input opening to ensure the lateral guiding of the said light guide support and of said mask.

6. The lighting and/or signaling device according to claim 1, in which said light guide support and said mask are elastically deformable for the snap-fitting of said tabs.

7. The lighting and/or signaling device according to claim 6, in which said light guide support and/or said mask comprise at least two segments each having a snap-fitting tab, said snap-fitting tabs of said at least two segments being displaced in different directions in the snap-fitting.

8. The lighting and/or signaling device according to claim 7, in which said light guide support and said mask each comprise two tabs that are displaced in substantially opposite directions.

9. The lighting and/or signaling device according to claim 8, in which said two tabs are displaced toward one another.
